(19) United States
(12) Patent Application Publication
(10) Pub. No.: US 2002/0147591 A1
(43) Pub. Date: Oct. 10, 2002

(54) System and method for remotely producing a response in a computer using acoustic signaling

(76) Inventors: Michael Beyo, Tel Aviv (IL); Rafael Beyo, Tel Aviv (IL)

Correspondence Address: LOWE HAUPTMAN GILMAN & BERNER, LLP, Suite 310, 1700 Diagonal Road, Alexandria, VA, 22314, US

(21) Appl. No.: 09/827,365

(22) Filed: Apr. 6, 2001

(51) Int. Cl. G10L 21/00; G10L 11/00

(52) U.S. Cl. 704/270

(57) ABSTRACT

A system for remotely producing a response on a computer using acoustic signaling, comprising at least one device adapted for producing at least one acoustic tone, and a computer for receiving the acoustic tone and for producing a response in accordance with the tone. The computer includes a microphone, a sound card, and specialized software, containing instructions specifically associated with the device. The software is adapted for checking characteristics of the tone including the frequency, amplitude, and time frame of the tone and for comparing the characteristics with predetermined expected characteristics such that when the received characteristics match a combination of predetermined expected characteristics, a specific response is produced.

### FIELD OF THE INVENTION

The present invention relates to the field of remote operation of computers. More specifically, the present invention relates to a system and method for remotely producing a response in a computer using acoustic signaling.

### BACKGROUND OF THE INVENTION

The advancement of computer technology in the past decade has allowed for many aspects of business and pleasure to be conducted in a very convenient and user-friendly manner. The present invention relates to a further innovation in computers that can be applied to numerous applications such as promotion and advertisement, leisure activity, and educational tools. Other uses are also possible, as it will be appreciated from the summary of the invention and detailed description of the drawings that follow.

### SUMMARY OF THE INVENTION

The present invention relates to a system for remotely producing a response on a computer using acoustic signaling, comprising;

(a) at least one device adapted for producing at least one acoustic tone, and;

(b) a computer for receiving said acoustic tone and for producing a response in accordance with said tone, said computer including a microphone, a sound card, and specialized software, wherein the software contains instructions specifically associated with said device and wherein said software is adapted for checking characteristics of the acoustic tone including the frequency, amplitude, and time frame of the acoustic tone and for comparing said characteristics with predetermined expected characteristics such that when the received characteristics match a combination of predetermined expected characteristics, a specific response is produced. The specific response may vary according to the user, and according to the parameters of use of the device (number of times of use, time of day, date, etc. . . . ). Furthermore, the specific preprogrammed response can be changed and upgraded at any time. Preferably, the device has a specific user serial number ID that identifies the user and that is input during installation of the software. During installation, the user might input personal preferences such as age, hobbies, place of residence, etc. . . . The specific response produced as the result of an acoustic signal may then be different according to the specific user profile.

In the context of the present invention, the term “computer” is meant to refer to any machine or device that contains a central processing unit or any other system that comprises of a CPU, and/or processing memory, audio input and output.

In the context of the present invention, the term “acoustic tone” may refer any appropriate acoustic tone, including simultaneous dual-tones (DTMF), simultaneous triple-tones, simultaneous multi-tones, non-simultaneous double-tones, non-simultaneous tri-tones, and non simultaneous multi-tones. Furthermore, the acoustic tone may be part of a music tone or song.

According to preferred embodiments of the present invention, the specific response is selected from at least one of: opening a web browser to a particular web site, and opening a computer application that is associated with said device. The response may include showing a slide or slide show, a video or streaming video, playing a song etc. . . . The specific response may be online or offline or any combination of both. It will be appreciated by those skilled in the art that there is a limitless number of possibilities for the responses that can be programmed to be produced.

Further according to preferred embodiments of the present invention, the characteristics checked by the specialized software further include at least one of the date that the acoustic signal was received, the time the acoustic signal was received, and the time elapsed since the last time an identical acoustic signal was received. In the context of the present invention, the “date” that the acoustic signal was received may refer to at least one of any of the following: the day of the week, the day of the month, and the day of the year, the hour of the day and the minute of the hour.

Additionally according to preferred embodiments of the present invention, the specific response changes according to at least one of the date that the acoustic signal was received, the time the acoustic signal was received, and the time elapsed since the last time an identical acoustic signal was received.

Moreover according to preferred embodiments of the present invention, the device adapted for producing an acoustic signal is selected from the group consisting of a mobile phone, a toy, a mouse pad, a watch, a game card, a piano, a keychain, a doorbell, and a credit card adapted to emit an acoustic signal. Other embodiments are also possible.

Still further according to preferred embodiments of the present invention, the frequency of the acoustic tone is between 4,000 Hz-22,000 Hz. Additionally according to preferred embodiments of the present invention, the acoustic tone is between 1/22 fraction of 1 second (45 Msec) and ¼ fraction of 1 second (250 Msec) in time duration.

Additionally according to preferred embodiments of the present invention, in non-simultaneous tones the time frame between the tones is between 1/22 fraction of a 1 second and ¼ fraction of 1 second. According to the time frame differences, different responses can be produced.

Moreover according to preferred embodiments of the present invention, said at least one acoustic tone comprises two acoustic tones and said time frame includes the time delay in between said two acoustic tones. Alternatively, said at least one acoustic tone comprises a combination of acoustic tones received one after the next. In these cases if the time frame between the tones is 1/22 there will be one type of response, but if the time frame is ¼ there will be another type of response.

In further preferred embodiments of the present invention, the specialized software is programmable by the user of the software. In other preferred embodiments of the present invention, the specialized software is programmable by the distributor of device. The specialized software may also be programmable by both the user of the software and the distributor of the device. In some embodiments, the distributor of the device can program the software via the internet or by any other communication network.

The present invention also relates to a method for remotely producing a response on a computer using acoustic signaling, comprising;

(a) producing, using a device, at least one acoustic tone;

(b) receiving, by a computer, said at least one acoustic tone;

(c) checking characteristics of said at least one acoustic tone including the frequency, amplitude, and time frame of the acoustic tone, and;

(d) comparing said characteristics with predetermined expected characteristics;

(e) producing a response when said received characteristics match a combination of predetermined expected characteristics.

### BRIEF DESCRIPTION OF THE DRAWINGS

The present invention is herein described, by way of example only, with reference to the accompanying drawings, wherein:

FIG. 1 is a schematic overview of a preferred embodiment of the system of the present invention.

FIG. 2 is a schematic overview of a preferred embodiment of the system of the present invention, showing an acoustic signal transmitter incorporated into a credit card.

FIG. 3 is a schematic overview of a preferred embodiment of the system of the present invention, showing an acoustic signal transmitter incorporated into a mouse pad.

FIG. 4 is a flow chart for a method for remotely producing a response from computer using acoustic signaling, according to a preferred embodiment of the present invention.

FIG. 5 is a graph of the amplitude versus frequency of an acoustic tone.

### DETAILED DESCRIPTION OF PREFERRED EMBODIMENTS

The detailed description that follows is intended only to illustrate certain preferred embodiments of the present invention. It is in no way meant to limit the scope of the invention, as set out in the claims.

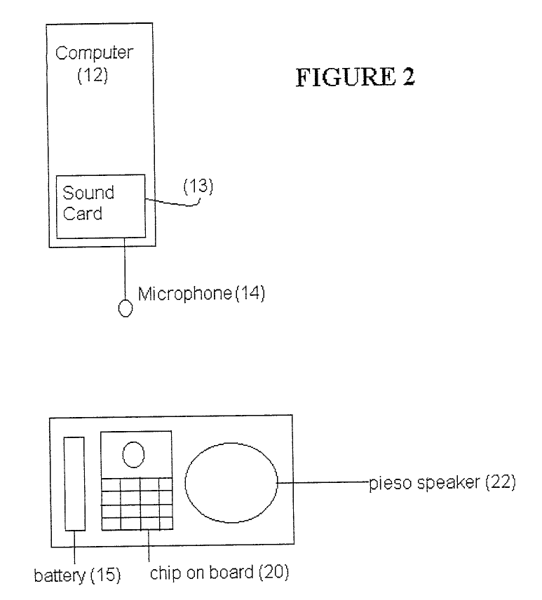

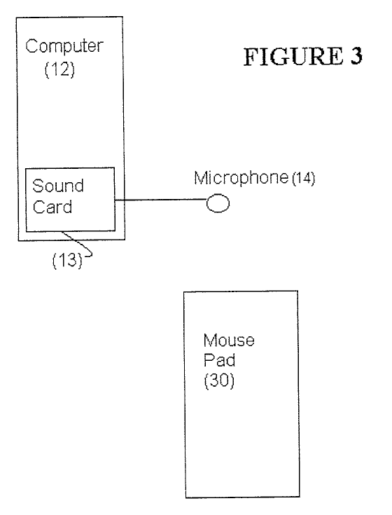

The system of the present invention includes a device adapted for producing at least one acoustic signal. The device may be any acoustic-tone producing device where the tone is between 4,000-22,000 hz. In some embodiments, the tones may be DTMF tones produced by a telephone or mobile phone. In other embodiments, a device is specially produced to include an acoustic signal transmitter so as to produce an acoustic tone in response to a user touching or pressing specific location or locations on the device. This will be described in more detail in FIGS. 2 and 3. For simultaneous dual tones (DTMF), simultaneous triple tones, and simultaneous multi-tones, the tones are between 600-1700 Hz. For nonsimultaneous double tones, nonsimultaneous triple tones and nonsimultaneous multi-tones, the tones are preferably below 2000 Hz and/or between 2000 and 6000 Hz. For nonsimultaneous double tones, nonsimultaneous triple tones and nonsimultaneous multi-tones, where at least one of the tones are ultrasound tones, the tones are between 4000 and 22,000 Hz. The device may be adapted for producing one tone only or a combination of tones by pressing on a single button. Alternatively, the device may have a plurality of buttons that each produce a different acoustic tone or combination of tones. The device is adapted for deciphering signals received even in a noisy background.

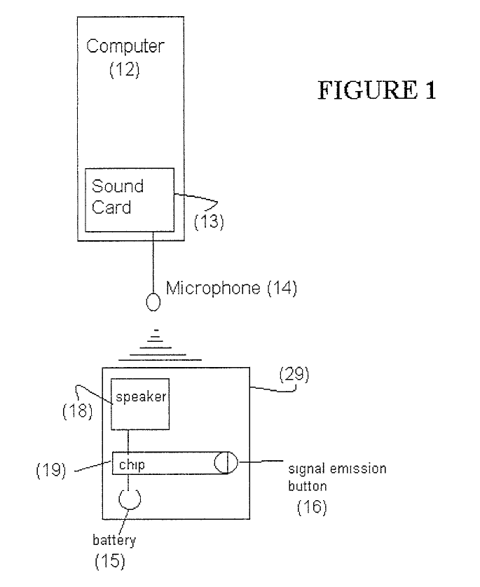

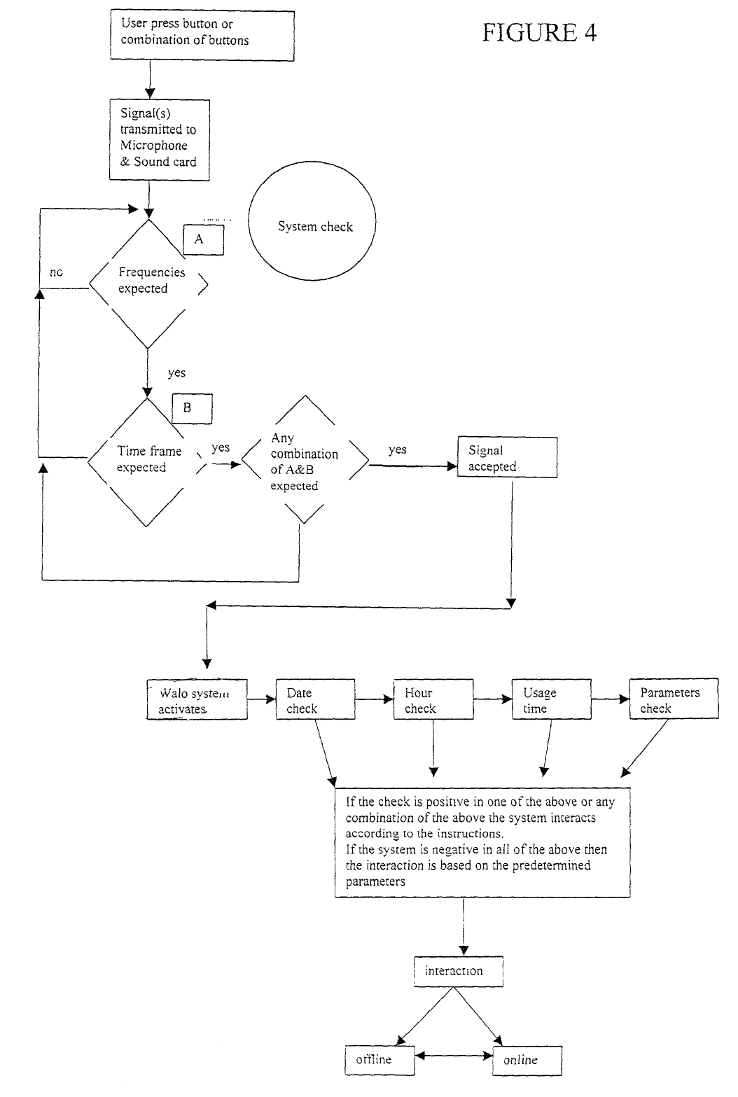

In the system illustrated in FIG. 1, the device adapted for producing an acoustic tone includes an acoustic signal transmitter (29), including a signal emission button (16), a microchip (19), batteries (15) and a speaker (18). When a user presses on the signal emission button (16), a specific tone is produced from the speaker and received by a computer (12). Preferably, the computer (12) is adapted for receiving signals from a distance of up to 5 meters. The computer (12) includes a microphone (14) for receiving signals, a sound card (13) for converting acoustic signals into digital signals, and specialized software, herein after referred to as “Walo” software. It is appreciated that in other computer systems, the sound card (including the microphone and/or the speaker) cannot be used for more than one application at the same time. In the system of the present invention, the system is constantly checking for the presence of acoustic tones of certain predetermined characteristics. Checking for these tones does not interfere with any other computer application that also uses the sound card. The Walo software contains source code and the Walo system that, in combination, check incoming signals for predetermined characteristics, and cause specific computer responses according to said predetermined characteristics. FIG. 4 shows a flow chart for a method for remotely producing a computer response via acoustic signaling using the Walo software.

In the system illustrated in FIG. 2, an acoustic signal transmitter having a battery (15), a chip located on a board (20), and a pieso speaker (22), are incorporated into a credit card (28). Preferably, at least one location on the credit card is adapted for pressing by a user to produce an acoustic tone via the acoustic signal transmitter. As in the system of FIG. 1, the tone produced is received by a computer (12) where it is converted to a digital signal and ‘read’ by the Walo software. It is appreciated that the system of the present invention allows for a +/−5% (approximately) error in received frequencies (for example, if the power of the battery of the pieso speaker weakens such that the emitted tone is slightly lower than intended). In the “credit card” embodiment of FIG. 2, the specific response produced may be, for example, opening an internet browser to a web site of the credit card company so that the user may view his account status, opening to a web site having special vacation packages for holders of the specific credit card, opening to a web site that the user designated, or any other appropriate response.

In the embodiment illustrated in FIG. 3, an acoustic signal transmitter (components not shown) is incorporated into a promotional mouse pad (30) adapted for producing an acoustic tone. This embodiment works in a manner similar to that of the system of FIG. 2 and is also capable of producing a plurality of specific responses according to the acoustic tones produced.

Other preferred embodiments of the present invention, not illustrated in the drawings, will now be described. It is appreciated that these embodiments are not meant to be limiting.

In a preferred embodiment of the present invention, the device producing at least one acoustic signal is a telephone or mobile phone. When the user presses a single button or a specific combination of buttons, the acoustic tones produced are received by a computer, where they are deciphered by the Walo software to produce a specific response. For example, using the system of the present invention a mobile phone may used as an “internet remote control”. In this embodiment, the Walo software loaded onto the user's computer is adapted to decipher different acoustic tones or combination of tones produced when the user presses different buttons or combinations of buttons on the phone. A specific button may correspond to, for example, opening of a specific website, for example www.amazon.com or www.cnn.com.

In another preferred embodiment, the acoustic tone or tones are produced from a watch worn by the user. In one example, the watch is adapted for elderly individuals such that in the case of an emergency, a specific button is pressed on the watch to produce an acoustic signal. The signal is received and deciphered by the computer to produce a specific response, such as relaying an appropriate message to a close relative of the user, or to an ambulance service.

In another preferred embodiment of the present invention, a children's toy is adapted for producing acoustic tones. For example, a doll has different signal emission buttons located on different parts of the doll's body. When the doll is turned on, a specific program related to the doll is opened on the computer. According to the buttons that the child presses, different acoustic tones are produced, and the child can learn about different body parts of the doll based in the response produced by the computer. The computer may provide a tutorial about the body part ‘pressed’ or it may engage the child in a “conversation” about the body part ‘pressed’. Other alternatives are possible as well.

In another embodiment two or more devices are adapted to emit acoustic tones. The devices interact simultaneously with a PC and, optionally, with the internet. The system recognizes from which of the two or more devices the expected signal is received and reacts to that one. Example of application are PC games where each user has his own device and the user that presses his device first wins.

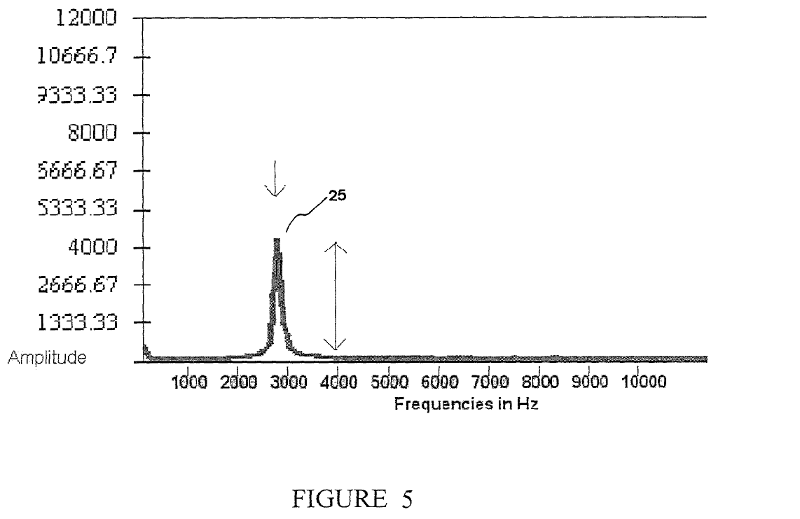

Reference will now be made to FIG. 5 and to the characteristics of an acoustic signal that are checked when an acoustic tone(s) is received. Two different methods can be used during the tone recognition process. An acoustic tone received having a peak (25) may be interpreted via two different methods. In the SUB (subtraction) method, the difference between the amplitude of the peak (25) and the average amplitude of neighboring peaks is measured. If the difference is greater than a given RATE number assigned, then the tone is detected and “valid”. If it is less than the RATE, the tone is ignored. In the DIV (division) method, the amplitude of the peak (25) is divided by the average amplitude of the neighboring peaks. If the resulting number is greater than a given RATE number, then the tone is detected and “valid”. If not, it is overlooked.

Acoustic tones are also checked for their height and all tones not having a certain amplitude are automatically disregarded.

The number of samples received in a predetermined time interval also determines whether the tone is “valid” or not. The software interprets incoming acoustic signals at a rate of 22 per second. Therefore, each second is divided into 22 parts. A recognition event occurs when a predetermined number of samples in the buffer length (a predetermined length of a second, for example, a buffer length of 5 buffers equal 5/22 of a second) have a predetermined peak amplitude.

1. A system for remotely producing a response on a computer using acoustic signaling, comprising;
(a) at least one device adapted for producing at least one acoustic tone, and;
(b) a computer for receiving said acoustic tone and for producing a response in accordance with said tone, said computer including a microphone, a sound card, and specialized software, wherein the software contains instructions specifically associated with said device and wherein said software is adapted for checking characteristics of the acoustic tone including the frequency, amplitude, and time frame of the acoustic tone and for comparing said characteristics with predetermined expected characteristics such that when the received characteristics match a combination of predetermined expected characteristics, a specific response is produced.

2. A system according to claim 1, wherein the computer is adapted for receiving and checking incoming acoustic tones while the sound card and microphone are being used for other computer applications.

3. A system according to claim 1, wherein the software allows for a predetermined tolerance level when checking any one of the frequency, amplitude, or time frame of an incoming signal.

4. A system according to claim 1, wherein the specific response is selected from at least one of: opening a web browser to a particular web site, and opening a computer application that is associated with said device.

5. A system according to claim 1, wherein the characteristics checked by the specialized software further include at least one of the date that the acoustic signal was received, the time the acoustic signal was received, and the time elapsed since the last time an identical acoustic signal was received.

6. A system according to claim 5, wherein the specific response changes according to at least one of the date that the acoustic signal was received, the time the acoustic signal was received, the time elapsed since the last time an identical acoustic signal was received.

7. A system according to claim 1, wherein the specific response is different according to individual pre-selected preferences of the user.

8. A system according to claim 1, wherein the device adapted for producing an acoustic signal is selected from the group consisting of a mobile phone, a toy, a mouse pad, a watch, a game card, a piano, a keychain, a doorbell, and a credit card.

9. A system according to claim 1, wherein the frequency of the acoustic tone is between 600 Hz-22,000 Hz.

10. A system according to claim 9, wherein the tones are DTMF tones, simultaneous triple tones, or simultaneous multi tones having a frequency between 600-1,700 Hz.

11. A system according to claim 9, wherein the tones are nonsimultaneous double tones, nonsimultaneous triple tones, or nonsimultaneous multi-tones having a frequency between 600-6,000 Hz.

12. A system according to claim 9, wherein the tones are nonsimultaneous double tones, nonsimultaneous triple tones and nonsimultaneous multi-tones having a frequency between 4,000-22,000 Hz.

13. A system according to claim 1, wherein the acoustic tone is between 0.05-1 second in time duration.

14. A system according to claim 1, wherein said at least one acoustic tone comprises two acoustic tones and said time frame includes the time delay in between said two acoustic tones.

15. A system according to claim 14, wherein the time delay between said two acoustic tones is between 0.05-1 second.

16. A system according to claim 14, wherein the time frame between the tones is between 1/22 second and ¼ fraction of a second.

17. A system according to claim 1, wherein said at least one acoustic tone comprises a combination of acoustic tones received one after the next.

18. A system according to claim 1, wherein the specialized software is programmable by the user.

19. A system according to claim 1, wherein the specialized software is programmable by the distributor of device.

20. A method for remotely producing a response on a computer using acoustic signaling, comprising;
(a) producing, using a device, at least one acoustic tone;
(b) receiving, by a computer, said at least one acoustic tone;
(c) checking characteristics of said at least one acoustic tone including the frequency, amplitude, and time frame of the acoustic tone, and;
(d) comparing said characteristics with predetermined expected characteristics;
(e) producing a response when said received characteristics match a combination of predetermined expected characteristics.

21. A method according to claim 20, wherein said time frame includes the buffer length of the tone.

22. A method according to claim 20, wherein said checking includes comparing the amplitude of the acoustic tone with the average amplitude of neighboring tones to determine acceptability of the tone.
